(19) United States
(12) Patent Application Publication
(10) Pub. No.: US 2019/0213407 A1
(43) Pub. Date: Jul. 11, 2019

(54) Automated Analysis System and Method for Analyzing at Least One of Scientific, Technological and Business Information

(71) Applicant: Teqmine Analytics Oy, Helsinki (FI)

(72) Inventors: Hannes Toivanen, Helskinki (FI); Arho Suominen, Turku (FI)

(73) Assignee: Teqmine Analytics Oy, Helsinki (FI)

(21) Appl. No.: 15/868,850

(22) Filed: Jan. 11, 2018

(51) Int. Cl. G06K 9/00; G06F 17/27; G06F 17/28; G06N 3/02

(52) U.S. Cl. CPC G06K 9/00456; G06F 17/277; G06N 3/02; G06F 17/2881; G06F 17/2785

(57) ABSTRACT

An object of the invention is an automated analysis system for analyzing at least one of scientific, technological and business information. The automated analysis system comprises means 100 for processing a data amount to accomplish a collection data form, means for structuring the collection data form describing the content of a source document, means for automatically identifying input documents in data warehouses comprising similar structured data forms as said structured collection data form, means for preprocessing and tokenizing said input documents, and the automated analysis system comprises a classification engine using the tokenized and preprocessed documents as input classifying each item of the input documents, and said means for processing, means for structuring, means for automatically identifying, means for preprocessing and tokenizing and said classification engine being configured to perform their tasks in one or more modelling round(s).

### FIELD OF THE INVENTION

The present invention relates to natural language processing of collections of documents for the purpose of analyzing scientific, technological and business information. In particular form the present invention relates to an on-line product, or software-as-a-service, for creating special purpose models of scientific or technical knowledge with or with the help of machine learning techniques, and making those models available for analysis and visualization through a graphical user interface or other on-line product that can include interactive functions.

### BACKGROUND OF THE INVENTION

Accurate analysis of scientific and technological information is of great importance for business, government and academia, among others, as this type of information is critical for a range of decision-making. However, the rapidly growing number of scientific and technological information, as well as the emergence of completely new bodies of knowledge, create a challenge for utilizing large and rapidly growing collections of data effectively.

Technology and patent landscapes, or maps, define and represent a complex body of knowledge or information in a manner that supports decision making or analysis. The basic problem of cartography of knowledge, including science and technology, is the delianation of accurate and valid coordinates.

Knowledge mapping, such as maps of science, technology or patents, have traditionally relied on human-reasoning based classification frameworks, such as key-words and technology classes, or other simple meta-data such as inventor and applicant names. The basic problem this approach is that fits new-to-the-world knowledge, such as patents with novel inventive steps, into historical models of technological knowledge, and cannot easily be deployed for new large-scale data sets.

Knowledge and technology maps typically rely on network analysis, but extend beyond. Types of science and technology maps and landscapes include term co-occurrence maps and visualizations, collaboration maps, disciplinary profile maps, citation maps, and different type of density maps.

Several service providers and software solutions have been introduced for science and technology map production. They include desktop software, such as software programs dedicated for analysis of science and technology: Vantage Point, Sci2 Tool, VosViewer. Some commercial patent search services provide landscape functions as well, such as Patsnap, Derwent Innovation , Patbase, and others. However, these landscape or map functions are often based only on abstracts, technology classifications, key word search, and other relatively simple methods of producing patent maps, landscapes, or visualizations. STN AnaVist is a dedicated landscape solution, but it lacks advanced machine learning capabilities for modelling and analysis. Several network analysis software applications exist too, such as Pajek, Gephi, and many others. Typical statistical programmes support this type of analysis too, such as R or SPSS, SAS and others.

Introduction of natural-language processing and machine-learning techniques to knowledge mapping, often defined as automated classification schemes, in contrast, generate classification models, that are used as the basis for cartographic coordinates, only from the available text corpus, thereby identifying credibly novel bodies of knowledge. Machine-learning based classification algorithms thus have the potential of analyzing vast amounts of data rapidly and to generate a wide range of knowledge models, which, in turn, can be employed to construct different type of patent and technology landscapes and maps.

Whereas machine learning solutions for natural-language processing and automated, or semi-automated, classification are well established and widely published, their integration into a method and system that solves the specific problems of decision making and analysis in the context of technology and patent information.

Natural language processing of patent records has received in particular attention, yet most solutions do not consider or mention that the choice of input text is critical. Modelling of technical knowledge by using patent abstracts, or by concatenating patent titles and abstracts, or enriching the aforementioned patent records fields with technology classification or applicant information, does not provide good data for discovery, due to the abstracts low information value. The same applies almost identically for scientific information, as well as software, research data, and so forth.

In the context of patent records, the full text description of patent records should be used, because it provides full disclosure about the background, inventive steps, figure text, as well as embodiment of the invention. Only by using the full text description of patents can one arrive at proper machine learning based model of technical knowledge, and this is what is put forth in this invention.

Whereas a typical abstract for a patent record or scientific article rarely exceeds 400 words, a description of a patent record can exceed hundreds of pages. Scientific articles run typically between 5 and 10 pages. Thus, the technical problem to analyze millions of full text documents with computer implemented methods is much greater than to process simple collection of abstract or other short fragments of documents within a collection of several million documents.

The fundamental problem for technology scanning is the difficulty to create high precision, high relevance technology maps in an agile, fast, and with a reasonable cost-benefit ratio. Traditional key-word or technology class classifications fail to meet the expectations of accuracy. If one is interested to map building elevator technology, key word search “elevator” will also yield a huge number of patents discussing the “elevator bar”, a technology that concerns how to scroll computer screens effectively and thus far removed building elevators.

The international patent classification (IPC) scheme provides the class “B66B” that is very useful for identifying patents that are relevant to building elevators. However, IPC or other technology classifications are available only for documents that have been classified by official patent examiners and been published. Furthermore, in many technology areas such classifications are inaccurate or they are missing altogether. Their use requires an understanding of the patent system and technology classification, and their sophisticated use requires often years of experience and training, making their incorrect use a very common phenomenon among people who conduct patent searches or create patent maps and landscapes.

Most challenging, however, is that such classifications are obsolete in recognizing how technologies become intertwined from a business perspective. For example, the increased use of software and software programmes to automate buildings has given a rise to a very large number of patents that are highly relevant for elevator technology, and thereby for elevator companies, but these patents are not classified in the IPC class “B66B”, and are thus difficult to identify or discover.

Similarly, such patents are difficult to identify with traditional key word searches, as their terminology and vocabulary are dominated by software technology, and a reference to elevators and buildings may be done only in passing. An example of such a patent is easy to produce, and one is WO2016109838, Automated handling of a package delivery at a smart-home by Google Inc.

For a company that has invested into business and R&D in elevators for buildings, discovery of such patents is very important and would have multiple implications for strategic decision making, as they would signal the entry of one of the world's largest software companies into their business domain. Simply monitoring Google's all patents would not provide a remedy either, because Google Inc. applies for such a vast number of patents.

Further problems for accurate and cost-effective technology scanning are presented by the nature of technological change itself. By definition, new to the work technologies do not have clear historical examples, and novel technologies depart from existing vocabulary, terminology, as well as conceptual and theoretical frameworks.

A particular problem for anybody trying accurately depict new technologies and bodies of knowledge is presented by the fact that such novel technologies and knowledge deploy vocabulary, terminology and concepts that may be familiar to a human being from another, historical, context. However, when terminology, vocabulary and concepts are deployed within a new to the world context, such familiarity is misleading and directs a human person to confuse records, pools of records, as well as technology or bodies of knowledge without scientific justification.

Another problem is caused by the fact that a term that has been introduced within one context gains significance within another one. A well-established example is the term “gay”, which in original use has connotated “happy” or “cheerful”, but in contemporary use connotates homosexual orientation. Cultural, historical, and linguistic, and other differences in the use of terms by human beings and computers often also establish that concepts or terms that appear similar or related are in fact not commensurable. In the context of audio, video, and images the above described problems are present too.

Although an important exercise, scanning of technology and patent environment is prohibitively difficult, costly and inaccurate with the solutions, systems and approaches available today. With the methods and systems in use, or published by today, requires a very large resource and effort, as well as is often highly inaccurate. Published and known solutions for software-as-a-service or as on-line products rely either on on one or a combination of the following: key word search, technology classifications, citation analysis, semantic search analyzing abstracts, summaries of patents, or concatenated fields such as abstracts enhanced with technology classifications and titles.

Moreover, such searches rely extensively on traditional indexing engines, such as Elastic search or Lucene, and are thereby prone to produce the mistakes and inaccuracies inherent to a search strategies that fundamentally reduce complex phenomenon into simple key words or catch-phrases. Not even a use of advanced boolean operators, such as near-by or similar type of operators, help to improve the accuracy of searches. Moreover, existing and known systems do not offer the possibility for continuous scanning or monitoring of complex, refined, and custom made patent and technology maps.

Existing and known technology and patent map and landscape solutions, when they are on-line-products, have a knowledge base of publicly available data, and do not allow the users seamlessly to integrate private documents into the mapping exercise. Such private collections can be unpublished invention disclosures or large collections of such documents, private manuscripts or any data, such as research material and databases, software code, project and product descriptions, and can include all type of digital files, such as text, image, video, voice, chemical compound information, curriculum vitae, and other types of digital data collections and documents not mentioned here.

Machine processing of large collections of text have previously relied on human assigned meta-data, such as key words, library classifications and so forth. With the advent of computerized collections and on-line collections, indexing of such collections relied on creation of aggregated filters, key-word extraction techniques, aggregation and modelling of human assigned classification data, such as industry classification, theme, etc, and other means of automatic processing of human assigned meta data. This work has included also the creation of new indexes based on modelling of human assigned meta data to guide human exploration of large collections of documents or information streams.

However, the introduction of machine learning based natural language processing techniques has prompted a departure from such approaches, and range of solutions that rely on machine learning have been proposed.

Blei, David M., and John D. Lafferty. “Dynamic topic models.” Proceedings of the 23rd international conference on Machine learning. ACM, 2006, demonstrates an approach to analyze the evolution of topics by using topic modelling, again by using a large collection of scientific literature.

Du, Lan, Wray Buntine, and Huidong Jin. “Modelling sequential text with an adaptive topic model.” Proceedings of the 2012 Joint Conference on Empirical Methods in Natural Language Processing and Computational Natural Language Learning. Association for Computational Linguistics, 2012, describes an adaptive topic model with the ability to to adapt topics from both the previous segment and the parent document. However, in the context of patent data, this adaptive model relies on human assigned meta data, such as the technology classification International Patent Classification, and is limited in its ability to be trained with full-text data.

US 20150046151 A1 “System and method for identifying and visualising topics and themes in collections of documents” discloses a system and method to estimate and visualize a plurality of topics in a collection of documents with two rounds of topic modelling. It proposes a method to estimate the number of topics in a collection of documents, and a process to reduce the number of those topics to such a number that permits feasible human analysis, as well as a process to model a collection of data so that it can be analyzed and visualized.

A number of prior publications disclose methods to carry out advance analytics or predictive analytics based on topic modelling of patent or science data.

Toivanen, Hannes, and Michael Novotny. “The emergence of patent races in lignocellulosic biofuels, 2002-2015.” Renewable and Sustainable Energy Reviews 77 (2017): 318-326, discusses a semi-supervised learning approach for technology and patent mapping. First, the authors text-mine a very large patent record collection, and subsequently carry out an unsupervised learning classification with the data.

However, the authors need to solve the problem of accurately depicting very small technology area, that of lignocellulosic biofuels, embedded within two much broader technology areas, those of lignocellulose processing and biofuels. This presents very specific problems: The vocabulary and corpus of their interest area does not differentiate sufficiently to enable easy discovery with traditional methods, and, secondly, the traditional technology classifications turn out to be unhelpful. Thus, the authors need to create a smaller and more detailed map, and in effect to carry out a 3^{rd} round of modelling, where records are chosen for modelling based on their combined classification in a matrix established by automated classification and International Patent Classification technology classifications.

Whereas the above mentioned prior art focus on solving the problem of classification, automated reduction of number of topics, and automated summary, they do not provide a solution for continuous monitoring of selected are of of user interest within a system that integrates a knowledge base, modelling, and graphical user interface to access individual records or for analysis and visualization purposes.

Particularly, the above mentioned patents rely on the assumption that machine learning or automatically created classifications are sufficient for proper analysis of documents, whereas the present invention maintains that such classifications are insufficient to provide for comprehensive and detailed analysis of scientific or technical information contained in individual documents. Thus, the present invention maintains that machine learning generated classifications, such as topics, are to be used as guides for human analysis.

Moreover, most of above mentioned solutions and prior art fail to provide a seamless and intuitive exploration and search process that integrated all aspects of creating a patent and technology map, landscape, or scan.

### SHORT DESCRIPTION OF THE INVENTION

An object of the present invention is to utilize advanced machine learning and natural language processing that allows searches to be conducted with a full-text description or a very long text in order to prevent the search query from truncating into simplified search key words or technology classifications, thus increasing reliability of the searches. This is achieved by an automated analysis system for analyzing at least one of scientific, technological and business information. The automated analysis system comprises means for processing a data amount to accomplish a collection data form, means for structuring the collection data form describing the content of a source document, means for automatically identifying input documents in data warehouses comprising similar structured data forms as said structured collection data form, means for preprocessing and tokenizing said input documents, and the automated analysis system comprises a classification engine using the tokenized and preprocessed documents as input classifying each item of the input documents.

The focus of the invention is also an automated analysis method of analyzing at least one of scientific, technological and business information. In the automated analysis method is processed a data amount to accomplish a collection data form, is structured the collection data form describing the content of a source document, is automatically identified input documents in data warehouses comprising similar structured data forms as said structured collection data form, is preprocessed and tokenized said input documents, and is classified using the tokenized and preprocessed documents as input documents classifying each item of the input documents, and said processing, structuring, identifying, preprocessing, tokenizing and said classification being configured to perform their tasks in one or more modelling round(s).

An object of the invention is also an artificial intelligence system for creating a synthetic document, wherein the system is configured to model text generation on basis of selected documents of interest in a specific field to form a model to which seed terms are given to be used as a starting point for the synthetic document, and the system is configured to automatically generate synthetic text on basis of the formed model and given seed terms to create the synthetic document.

The object of the invention is further an artificial intelligence method for creating a synthetic document, wherein is modelled text generation on basis of selected documents of interest in a specific field to form a model to which seed terms are given to be used as a starting point for the synthetic document, and is automatically generated synthetic text on basis of the formed model and given seed terms to create the synthetic document.

The invention is based on one or more classification algorithm(s) that is embedded in data warehouse and web application system, and this allows a user to access and control the entire system.

A benefit of the invention is that that the search objective can be defined with almost unlimited complexity. The fundamental benefit that artificial intelligence offers for search is that it exploits the complexity of the search document for better accuracy and relevance, and can therefore superior performance over traditional search methods that truncate complex search objectives into simple key words or technology classifications.

### SHORT DESCRIPTION OF THE FIGURES

FIG. 1 presents a flow chart presentation of the system related to the present invention.

FIG. 2 illustrates the method related to the invention.

FIG. 3 presents a flow chart presentation of the system according to present the invention.

FIGS. 4-9 present exemplary preferred embodiments according to the present invention.

### DETAILED DESCRIPTION OF THE INVENTION

Techniques according to the present invention make use of a collection of data relating to science and technology developments to create a system and method of continuously monitoring user selected or created information against science and technology advancements. A collection of data can be any structured or unstructured data source with information relating to science and technology development. Examples of data that can be used are patent data, news data and science publications, and can also include data of scientific and technological information, research material databases, experimental research data, visual material, audio and video collections but are not limited to these.

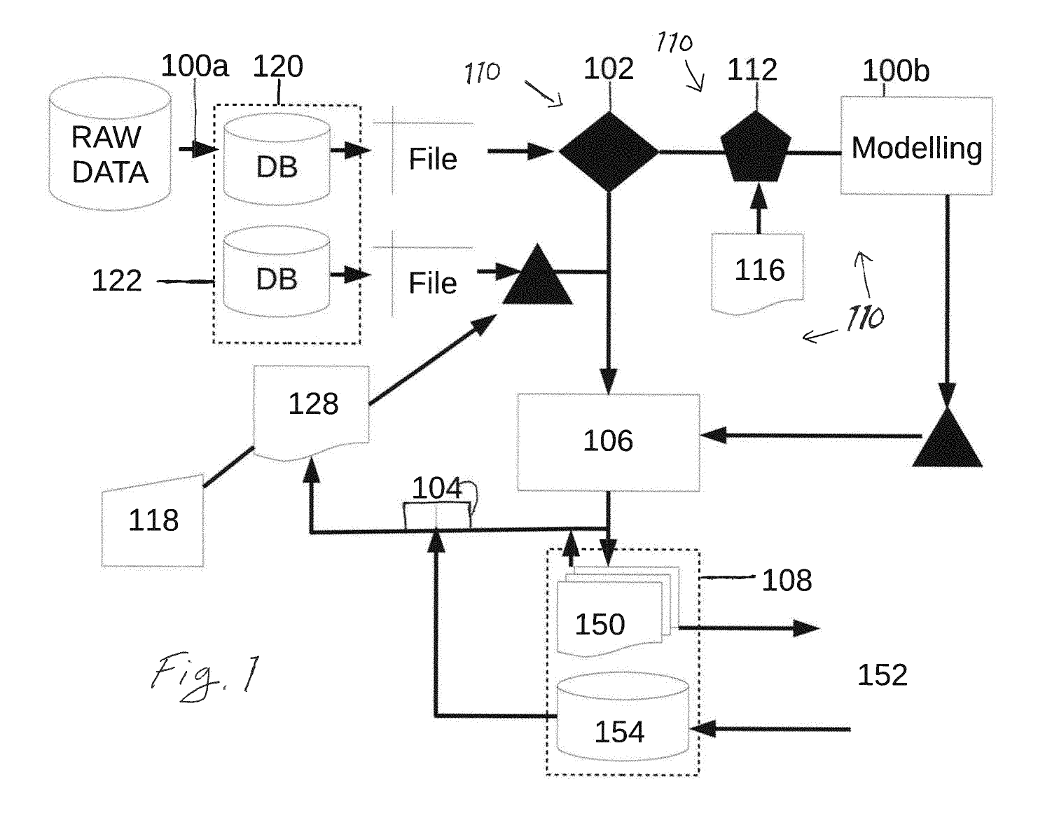

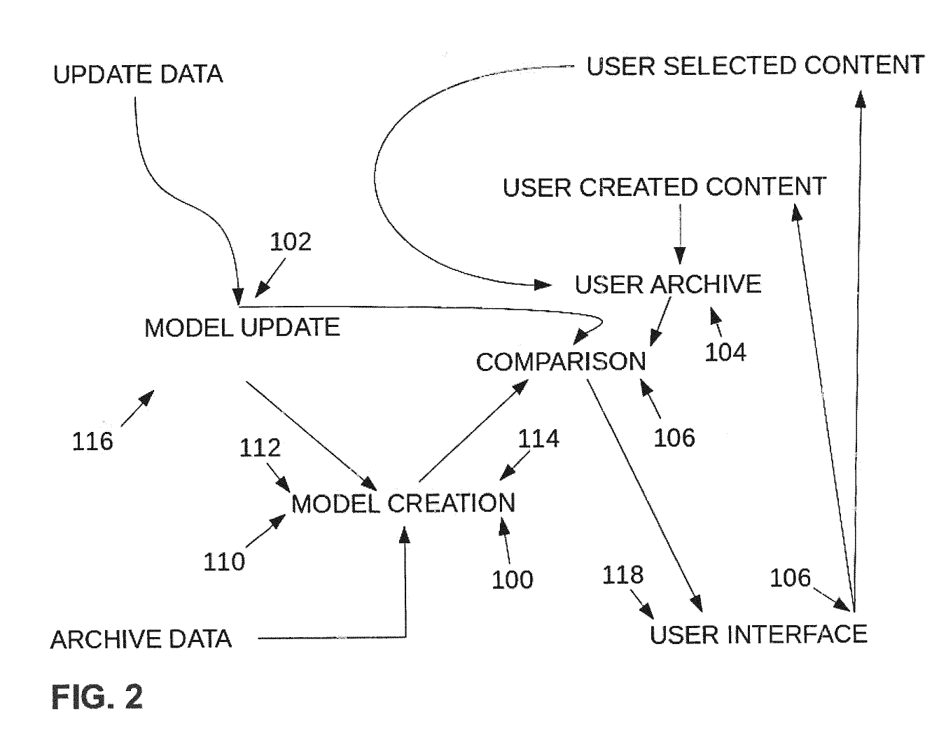

In FIG. 1 is presented a flow chart presentation of the system related to the invention. The automated monitoring and archiving system related to the present invention comprises means 110 for processing, a data amount to accomplish a structured collection data form. A collection of data can be sourced from publicly available data in structured format or web harvested. Data can also be sourced from proprietary format. Raw data is structured to a collection that can be structured to a flat file or a database 120. The data amount can be for example a collection of documents. The system can comprise means 110 for structuring the collection data form e.g. to meta information and textual data describing the content of a source document. The data collection can be structured to meta information and semantic text, figures, tables, video and/or audio describing the content of a record. The automated monitoring and archiving system according to the present invention can comprise means 102 for automatically identifying documents comprising similar structured data forms as said structured collection data form. The user can define identification models to a reference document database 122. The system can also comprise a storage for reference documents in a file mode.

The system according to the present invention can comprise means 112 for preprocessing in the case of textual data by using at least one method of sentence boundary detection, part-of-speech assignment, morphological decomposition of compound words, chunking, problem-specific segmentation, named entity recognition, grammatical error identification and recovery methods to reduce the complexity of the collection of documents.

The automated monitoring and archiving system comprises means 100b for modelling the collection data form by using at least one of an unsupervised, semi-supervised and supervised classification algorithm to accomplish a model of the collection data form. Examples of algorithms used are support vector machine, expectation-maximization, probabilistic semantic indexing and latent dirichlet allocation. The system can comprise means 116 for updating the collection data form to accomplish a new model by inferencing new data to the collection data form. The update models can subsequently be merged with the initial models.

The user can select documents from the collection or create documents included into the monitoring systems as records. The selected or created documents (later user records) are compared by classification using the model collection of documents. The comparison results in a similarity index value for each user document. The system creates a link between each user record and collection document. The link is weighted based on the similarity index of the two documents. The link data can be stored in in a result table that can be a file, database or database table. The system related to the present invention comprises means for 104 defining monitoring criteria, and means 106 for automatically analyzing the identified documents on the basis of the defined monitoring criteria. The system can also comprise a data file 128 for information on which similarities are in process. Said data file 128 can be linked to reference documents 122 process and/or to the automatic analyzation process 106.

The system related to the present invention can further comprise means for 108 automatically archiving said analyzed documents in an electronic record keeping system. In one embodiment according to the present invention the automated monitoring and archiving system 108 can comprise means 152 for performing automatic sub-archiving of the automatically analyzed identified documents. The automated monitoring and archiving system can be configured to operate as an independent identification and archiving robot by utilizing artificial intelligence and algorithm techniques. In one further embodiment the system can also comprise means 118 for integrating human analysis to the automatic analysis of the identified documents.

As new models or model updates based created based on the collection or collection updated, the similarity index values are automatically updated for each user record selected for monitoring. The system creates a link between each user document and collection document. The link is weighted based on the similarity index of the two documents. Using a system assigned or user selected similarity index threshold the process excludes low-scoring user record and collection document links from the result table.

The system according to the present invention can operate in an endless loop used for the continuous monitoring. Loop includes iterations where new or modified data can be included in the collection 120 (FIG. 1) resulting in model updates and new or modified user records 122 resulting in similarity index calculations. A termination condition for the loop can be set.

In the specific case that user created user records, the user can be directed to create a semantic description suitable for similarity indexing. The user is given a textual description of the type of text that can be included as user record. This textual description can also include an online form or a template file directing the user's interaction. Prior to similarity comparisons, user records are preprocessed. Preprocessing follows the preprocessing steps used to preprocess the collection. The user created user records are processed by weighting user identified keywords. The user can select user records from the collection, the records are copied as is or as a link from the collection to the user records and included in the similarity indexing process.

In the following is described more detailed embodiments related to the present invention.

Machine readable data can be stored in unstructured data warehouse, and transferred from there into structured data stored in data warehouse or in database. In one embodiment of the invention, patent publication data issued by Patent Office (e.g. USPTO, EPO or WIPO) in XML-format and including Portable Document Format (pdf) or images (such as .jpg or .tiff format) are obtained over the Internet from an FTP-server or other server of provided by the Patent Office and stored at a local computer or computer server or stored at a cloud-based server, such as offered as a service by Amazon or Microsoft or by several other service providers. Data downloading or harvesting is implemented with a software robot that operates in endless loop, or in batch-operation mode.

Data to be stored at the unstructured and structured data warehouse can also include data on scientific publications. Examples of such would be electronic files containing full publication information that several scientific publishers, such as Elsevier, Routledge, Francisc&Taylor, as well as several journals, such as PlosOne, generate and maintain for all publications published through their publishing systems.

Other types of data that can be stored at data warehouse can include research material and research data. This includes research datasets, research material, experimental data, or biological information data and other scientific and technical data deposited in research databases or research material platforms, such as www.researchgate.org, www.academica.edu or at the Mendeley Service. Such datasets can be, for example, genomic data, statistical data, patient data, experiment result data and so forth.

Furthermore, scientific and technological data can be harvested or downloaded to the data warehouse from various electronic sources, such as blogs, publicly shared MS Powerpoint or PDF presentations and materials, and data can also be harvested from various open repositories, such as Mendeley, Google Scholar, Google Patents, Academia.Edu, www.researchgate.org, as well as from publication repositories maintained by universities, research organizations, governments, and other organizations. Examples of such institutional public science and technology repositories are the various universities (e.g. https://smartech.gatech.edu/, which includes in 2016 more than 40,000 Georgia Tech theses and dissertations in full-text). Data can also be obtained from websites that host information on academic courses or course materials.

Additionally, data can be harvested from science and technology conference websites, where often abstracts, proceedings and presentation materials are made publicly available over the Internet. Data can also include audio and visual electronic data, for example videos or recordings of presentations at scientific or technological conferences or other venues. Data can also be reports, books, academic dissertations, and so forth. Data sources can include other sources than those previously listed.

Data for the unstructured and structured data warehouse can also be obtained confidentially in a manner where it is subsequently made available only for selected users or parties. For example, a large and R&D intensive company can provide as a data its own internal, confidential and non-disclosed research reports and materials to be included in the data warehouse and subsequent modelling, monitoring and analysis. One reason for such action would be to detect easily and accurately if anybody or any firm would attempt to obtain a patent on an invention that the firm has documented prior-art, and the firm would like to prevent the grant of such patent.

The data can consist of back-file and updates. In one embodiment, the back-file consists of the historical full-text patent publication data including images and pdf-files of original patent publications issued by EPO, USPTO or WIPO since 1978. Updates consist of the weekly publications by EPO, USPTO and WIPO of new patent publication data. Another embodiment of the back-file would include the electronic scientific publication data that is available from ThomsonReuters (Web of Science), Elsevier (Scopus), PubMed and several other scientific publishing houses. This includes also publication record data from individual journals, such as PlosOne and several other Open Science journals, as well as publication level electronic information that can be obtained from Open Access articles at journals otherwise maintaining paywall. In each of these embodiments, as well as in other embodiments, there exists a clear historical data set that can be downloaded or saved to data warehouse, and there exist regular or irregular updates to the dataset.

The data can consist of only one-time data. For example, publications or files from a scientific conference that will not have succession conferences or publication data from a book that will be published without a sequel.

The downloaded data, consisting in one embodiment of the invention of patent publications are stored in data warehouse in .xml, .pdf and .tiff format electronic publications are parsed by using a specifically developed parsing script into structured data format, and stored in the computer. Other embodiments can include any electronic and machine readable file formats. In one embodiment, the parsed data is loaded in structured relational database, such as MySQL, MariaDB, Microsoft Server SQL or other known database format. The database will identify all publication level data by using the official identification tags, such as publication number or application number other known official identification tags, and can also include identification tags added to records during the parsing process or when loaded in the database.

The downloaded data can also be structured and stored in the original or new data warehouse. In this embodiment, the files are stored in data warehouse in structured and logical archive and with necessary file identifications so that publication information and meta-information can be retrieved efficiently to be displayed at graphical user interface for users, or to be retrieved efficiently for text or data mining, or for modelling. Data can also be stored in several dedicated data warehouses by its origin, date or kind or by other features.

The database consisting of the patent publications of an issuing office, such as EPO, USPTO or WIPO, may include all publicly available information and meta information, such as title, abstract, full-text description, claims, applicant, assignee, technology classifications, inventor names and addresses, kind, publishing country, priority date, application date, publication date, assignee and legal changes, search reports, cited patent and non-patent literature, and so forth.

Data on patent publications can also include data generated by using other databases, such as the EPO maintained DOCDB master documentation database, EPO issued, PATSTAT database or EPO Worldwide Legal Status Database INPADOC, or other patent databases and can consist of, for example, backward and forward citation counts, patent family information, and so forth. Patent publication data can also be enhanced with EPO maintained INPADOC information about the legal status of the patent publication, for example if it has been granted, in which country it has been granted, or its possible lapse due to various reasons. Additional data can also include information on license agreements concerning the patent publication, as well as if patents have been recorded as ‘notified patents’ in established industry standards, such as in common in the ICT industry.

Data on patent publications can also be enhanced by generating information not publicly available, such as machine-generated or human expert evaluations about their novelty (e.g. based on patent citation count or expert opinion), machine-generated or human expert assigned information about the technical or business field of the patent publication, information about legal events, such as infringement or other legal challenges, patent portfolio analysis, and so forth. The reason to add such information on patent publications would be to facilitate patent publication search or to enable financial or other technical analysis of large data sets.

The structured data warehouse or database can be optimized for various user purposes. A major reason would be to enable effective text and data mining that would be enabled by indexing of the data, and a range of traditional search methods. This is done by using the basic indexing commands available in MySQL, MariaDB and other databases. Additional search facilitating indexing is done by implementing Lucene Search Index or Elastic Search in the database to enable effective text search and text-mining capabilities.

In the embodiments related to the present invention can be made use of a collection of data relating to science and technology developments to create a system and method of continuously monitoring user selected or created information against science and technology advancements. A collection of data can be any structured or unstructured data source with data relating to science and technology development. Examples of data that can be used are patent data, news data and science publications, and can also include data of scientific and technological information, research material databases, audio and video collections but are not limited to these.

A collection of data can be sourced from publicly available data in structured format or web harvested. Data can also be sourced from proprietary format, such as privately held collection of technological records by an organization. In one embodiment, such records is a collection of invention disclosure by a corporation, which are used as documents to search and monitor for relevant scientific and patent publications with the method and system disclosed herein. Raw data is structured to a collection that can be structured to flat file or a database. The collection is structured to meta information and semantic text, figures, tables, video and/or audio describing the content of a record.

In one embodiment, the collection of data is sourced in raw data format from data providers which are the patent administrative offices i.e. United States Patent and Trademark Office, European Patent Office or WIPO. The data files are read, cleaned and written to a data warehouse that is a database. In one embodiment, the natural language description of the invention is extracted with a unique identifier from the database. The semantic text of one more several collections of data is used to create a model reducing the dimensionality of the text. This model can be known or future supervised, semi-supervised or unsupervised learning method, in on embodiment this is Latent Dirichlet Allocation. During the model creation process, files describing the created model, each document in the model and the data of publication of the last document are stored in the system. As the data provider or other sources makes new data available for the same collection of data, new data is added to the existing data warehouse. Using the date of last document modeled, the system extracts documents not previously modeled from the database and by using inference creates values for each new document in the model. The system also updates the publication data of the last document modeled. The process of updating is an infinite loop, where the user can set constraints on when new data is queried from the data provider and when values are created for new documents. The user can set a termination condition for the loop. In one embodiment, the termination condition for the loop is the ratio of new documents per the count of documents in the original collection of data. When the ratio increases above a constraint value set by the user, the whole collection is modeled again, creating a new model and starting a new loop of updates.

The model is created by a sequence of inputs, referred to as data, extracted from data structure at a given time. The data extracted can correspond to for example images, sound waveforms or textual information and is extracted based on the user choice of data and what is available in the data structure of a given data collection. The data is a sequence of inputs, where the sequence is controlled by the unique identifier given to each document when creating the data warehouse.

The extracted data from the data structure can be preprocessed prior to analysis. The data serves as an input to a machine learning algorithm, which can be any known and future supervised, reinforced or unsupervised learning algorithm. With the model, the algorithm creates a soft or hard partitioning classifying each input sequence to one or multiple classes. The model produces a vector, length of one if hard partitioned and length the number of classes in soft partitioning, giving the class and/or probability of document belonging to one or more classes. Document classification is thereafter used to calculate a similarity index value between input documents and any new document introduced to the model. This can be done by for example identifying, in the case of hard partitioning, documents belonging to the same class, or, in the case of soft partitioning, by calculating the cosine similarity between all documents included into the model.

In one embodiment, the model is created using unsupervised learning via Latent Semantic Indexing (also known as the Latent Semantic Analysis) to model all of the USPTO issued patent text between 1978-2015, consisting of approximately 7 million records. In this, the sequence of inputs, patent documents, are controlled via a preprocessing phase where after data is classified using the algorithm. In addition to the input, the algorithm is given the number of classes the input is to be classified. The Latent Semantic Indexing algorithm produces a soft classification with each sequence of input being classified to multiple classes. Documents distribution in classes is thereafter considered as a vector and compared to each exiting and new document in the data structure by cosine similarity between vectors. In this one embodiment, the cosine similarity between documents is the similarity index value between two documents.

The preprocessing of documents prior to modeling cleans the sequence of inputs from character, terms and/or tokens that do not distinguish the content of the document but are relevant to the type of content. These are for example words not containing information about the content but create natural language, such as prepositions and punctuations, or sections of image that show only commonly used logos. In one embodiment, semantic text can be preprocessed to reduce the complexity of the collection of documents. Textual data can be preprocessed using methods such as, but not limited to, sentence boundary detection, part-of-speech assignment, morphological decomposition of compound words, chunking, problem-specific segmentation, named entity recognition or grammatical error identification and recovery methods. In the specific embodiment of patent text, semantic text can be further preprocessed to remove legal terminology pertaining to how patent text is written, such as removing “in this embodiment”. In specific embodiment of publications text, semantic text can be further preprocessed to remove structures such as “all rights reserved” and “in this paper”.

The user can select documents from the collection of data in structured data or other data made accessible, use documents identified or obtained from elsewhere (e.g. newspaper, scientific journal, blog post) or create documents (such as invention disclosures, drafts for scientific manuscripts or patent application drafts) to be used as reference documents for monitoring and analysis. A reference document embodies the scientific or technical area of interest for the user, and is included in the monitoring systems as records. The selected or created reference document or documents, as the invention allows the monitoring of unlimited number of reference documents, are compared by classification using the model collection of documents. The comparison results in a similarity index value for each user identified reference document. The system creates a link between each reference document and collection document. The link is weighted based on the similarity index of the two documents. The link data is stored in in a result table that can be a file, database or database table.

As new models or model updates based created based on the collection or collection updated, the similarity index values are automatically updated for each reference document selected for monitoring. The system creates a link between each reference document and collection document. The link is weighted based on the similarity index of the two documents. Using a system assigned or user selected similarity index threshold the process excludes low-scoring reference record and collection document links from the result table.

The system operates in an endless loop used for the continuous monitoring. Loop includes iterations where new or modified data can be included in the collection resulting in model updates and new or modified reference records resulting in similarity index calculations. A termination condition for the loop can be set.

In the specific case that user created reference documents, the user is directed to create a semantic description suitable for similarity indexing. The user is given a textual description of the type of text that can be included as user record. This textual description can also include an online form or a template file directing the users' interaction. Prior to similarity comparisons, user records are preprocessed. Preprocessing follows the preprocessing steps used to preprocess the collection. The user created user records are processed weighting user identified keywords.

In the specific case that the user selects reference documents from the collection, the records are copied as is or as a link from the collection to the user records and included in the similarity indexing process.

Results data can be integrated from data modelling and monitoring into graphical user interface (GUI). Data results from data modelling and monitoring (Similarity Index) are integrated into structured data or database to obtain full record level meta data. Results data is stored as additional structured data or, in one embodiment, inserted into MySQL or other relational data base table. By using record level unique identifiers, the records are connected to available meta and other data related to the said record.

This integration will enable human user to assess and access modelling results. Access to results is realized via graphical user interface (GUI) that allow the user to access and evaluate the modelling results. The GUI is implemented in established programming techniques, such as Java, and it accessible from computer devices connected to public or private Internet. The GUI is hosted on a computer server or cloud.

In one exemplary embodiment related to the present invention the GUI has several functionalities typical to large-scale databases, and it will allow the user to carry out indexed search in the structured data in its entirety, i.e. all data warehouse data is available.

In case of the integrated modelling results, the GUI has several dedicated features, such as automated reporting on the qualities of the results data. This includes the number of patent applications per year, listings of key assignees, inventors, inventor cities etc. Data is provided in graphical report formats as is possible with the solutions provided by dedicated business intelligence software companies such as Vaadin Inc or Tableau Software. Data is provided also in table formats and the GUI allows the user to download graphs, tables or complete reports in different data formats.

The GUI includes user management system, and each user has access to a set of modelling results are provided with the privileges associated with that given user account or user group. The user account information privileges are connected to user account information associated with specific modelling results.

A user can browse, search, sort, filter and in different ways classify modelling results per all the data stored in structured data, such as publication date, publication number, technology class, inventor or author name, assignee, author organization. A dedicated indexed search engine, such as Lucene or Elastic search, will allow the user to carry out complex text based search, such as Boolean search. All search, filter and classification operations can be saved, scheduled and automated to be operated in infinite loop.

The user can save any record or number of records to specific lists to keep records for certain special interests. Lists are realized in structured data or in MySQL as special table, and linked to record level data via unique identifier. The lists are maintained, for example, to identify all patent publications where claims contain specific term of interest, or all patent publications of a given company or inventor, or all patents with a given technology classification(s). Such lists will be essential for a user to keep records for special areas of interest to be monitored, and they can be accumulated over time in indefinitely.

The user can also browse data and other information in the GUI by filtering results by the unique identification of reference document.

Automatic monitoring and archiving is realized at different levels of precision. In the first instance, automatic monitoring and archiving in the invention is realized by the modelling automatically selecting relevant records from the structured data and data updates for a reference document or multiple reference documents, which are estimated relevant and then automatically moved to the structured data so that a user can access them. However, such data may include too much of undesired data, and the user can add precision by using the filtering, search, and classification tools embedded in GUI.

Another level of precision is enabled by the creation of dedicated lists to keep records of certain records of interests. Such lists are created by automatically adding all records from the model and new updates that correspond to scheduled or automated search, filtering or classification created by the user. For example, by using functionalities of the GUI, the user may automate the process where by all patent publication records and new patent application records whose claims contain a specific term (e.g. thermoplastic) are included to a pre-defined list. The automated storing of records is realized as a scheduled and automated search using the indexed search and by storing all captured records automatically to a pre-defined list.

The user can also keep records and maintain archival system of them by manually carrying out search, filtering and classification of the modelling results with the functionalities of the GUI.

The user can also improve the quality of automated and semi-automated archived record keeping lists by manually verifying the quality of saved records and by removing undesired records from the list.

All reporting functions of the GUI can be adapted to display results, graphs or figures for the saved lists.

An analysis system and method according to the present invention integrates the different necessary elements and aspects into a system and method that supports production and delivery of patent technology maps as software-as-a-service-type solution. The system integrates a large scale knowledge base that can be updated continuously with new data into a machine learning engine, as well as into a graphical user interface that allows users to use and access the service via a computer device connected to other computer, or network of computers.

In a system and method according to the present invention for technology scanning and patent landscape or map is modelled a knowledge base with natural language processing and machine learning techniques. A user can identify areas of interest for technology scanning or patent landscape analysis either from a pre-existing model, or by using at least one of unsupervised, semi-supervised and supervised methods to train specific purpose model of data. The selected or created model can be used for continued technology scanning by updating it with new data as the knowledge base is being updated. The selected or created model can be used, modified, updated, analyzed and visualized through an on-line product or graphical user interface, and it includes interactive features for training, analysis, visualization and discovery purposes.

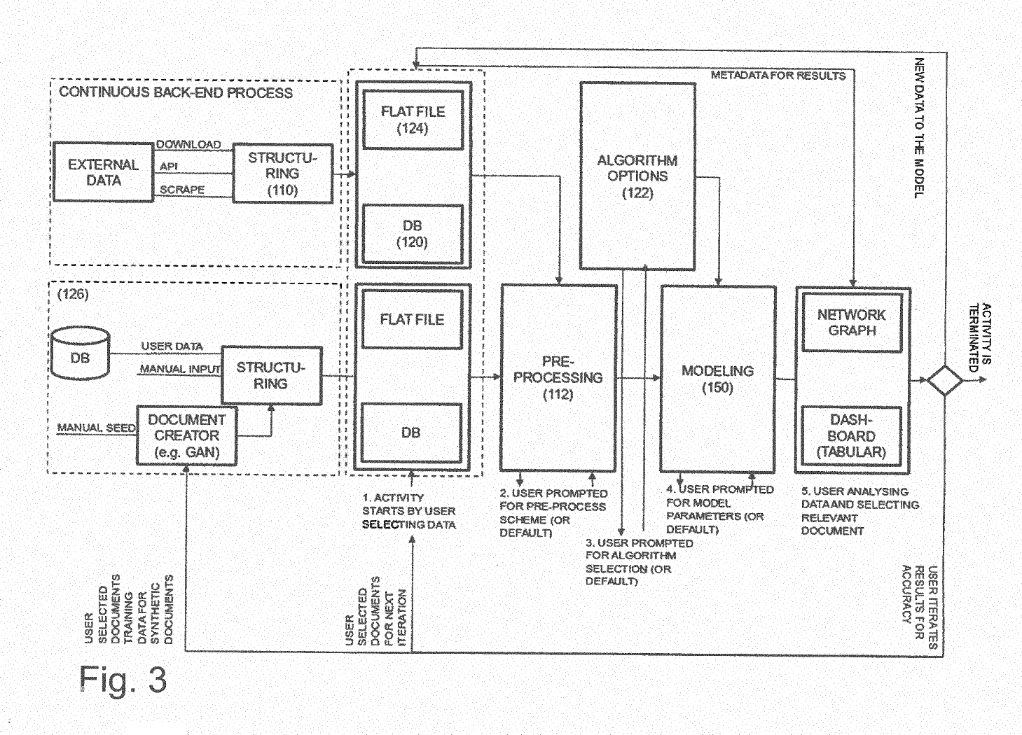

In FIG. 3 is presented a flow chart presentation of the system according to the invention. The automated monitoring and archiving system according to the present invention comprises means 110 for processing a data amount to accomplish a structured collection data form. A collection of data can be sourced from publicly available data in structured format or web harvested. Data can also be sourced from proprietary format.

Raw data is structured to a collection that can be structured to a flat file 124 or a database 120. The data amount can be for example a collection of documents. The system can comprise means 110 for structuring the collection data form e.g. to meta information and textual data describing the content of a source document. The data collection can be structured to meta information and semantic text, figures, tables, video and/or audio describing the content of a record. The automated monitoring and archiving system according to the present invention comprises means 102 for automatically identifying documents in data warehouses comprising similar structured data forms as said structured collection data form. The user can define identification models to a reference document database 122.

In one embodiment, the database is a MySQL database that consists of several relational databases, including databases dedicated for data processing, data storage, and serving on On-Line application or Software-as-a-Service front-end application that is accessible via the Internet. The database infrastructure can also be realized with any other database solution, such as MariaDB, Microsoft SQL server, Oracle Database and other.

The system can also comprise a storage 126 for reference documents in a file mode. The system according to the present invention can comprise means 112 for preprocessing in the case of textual data by using at least one method of sentence boundary detection, part-of-speech assignment, morphological decomposition of compound words, chunking, problem-specific segmentation, named entity recognition, grammatical error identification and recovery methods to reduce the complexity of the collection of documents.

A classification system is based at least on one of the following: supervised, unsupervised and adaptive machine learning mechanism including but not limited to Support Vector Machine, Hidden Markov model, Naive Bayes classifier, k-nearest neighbor, Latent Semantic Analysis, Latent Dirichlet Allocation, CNN text classifier, and Recurrent Neural Network. The classification system creates a classified representation of the input, which can be preprocessed and tokenized prior to classification.

A classification engine 150 uses the tokenized and preprocessed data as input classifying each item in the input data. Items can be, but not limited to, documents or images. The classification can be a soft classification, with each input being a classification to multiple classes, or hard classification, where an input belongs to one class. The classification engine is dynamic, where the user can filter the input data, change the classifier, change the classifier parameters or results representation on demand.

In one embodiment, the input data is retrieved from a database of all global patents or selected patent offices. Other embodiments could include public or private data collections, on-line or off-line data collections, including research publications, research publication databases, research material and research data databases, university thesis collections, research organization research publication collections, software and algorithm collections, product descriptions, company and business descriptions, invention disclosures, curriculum vitae or other professional development data, audio and video, and other type of data not limited to above mentioned examples.

In one embodiment, the patent documents are retrieved from multiple patent offices thereafter merged to a single data structure, which in this embodiment is a database but it can also be any structured data storage. The data is extracted from the database s for preprocessing either in totality or by limiting to a portion of the data by using for example database queries. The analysis begins with selecting the raw data that is used to represent each item in the data. In one embodiment, for patent data based technology scanning we extract the description section of each patent. In this embodiment the analysis is limited to a lexical analysis, thus excluding all figures from the patent descriptions. This filtered data is used as a input to preprocessing and tokenization.

Tokenization is based on employing commonly used data processing methods, which can be but not limited to stop word removal, removing the most and least occurring words, removing punctuations merging ngrams, identifying phrases or events. In one embodiment the input data containing the description sections of patents is tokenized using a scheme where prior to creating tokens the most and least occurring words, stopwords and punctuations are removed. In addition ngrams are merged. Each patent document is tokenized, converting patents to vectors using a bag-of-words representation. Each unique word in the whole input is assigned to a unique integer id creating a dictionary of unique words represented by integer tokens. Using the dictionary created patent documents are converted to a vector of ids.

The tokenized data is input to the selected classifier. In one embodiment, the tokenized data is input to Latent Dirichlet Allocation that is used to create a classification of the input data. In this embodiment the result is a soft classification of documents to topics, where topic content is described by the probability of tokens belonging to a topic. In this embodiment classifications are given as a probability of a patent belonging to each of the topics (classes). Each document classification is defined as a distribution of probabilities across topics. In practice patents have a high probability of belonging to a small number of topics, with the majority of document to topic probabilities being small. This creates a soft classification of patents to topics. Topic content is, in this embodiment, described by word to topic probabilities where each word has a probability of belonging to a topic.

The user interacts with the data by evaluating the initial model, which is a classified representation of the full data or a custom filtering of the whole data defined by the user. The user can evaluate the classification results and evaluate parameter settings by multiple different methods that are partly dependent on the classifier used. Common approached used to evaluate classifier performance are, but not limited to, Receiver Operating Characteristic, False positive rate, F-score, Confusion Matrix, intra-cluster variance or qualitative analysis of classes using sampling or automated summaries, labels or wordclouds representing classes. In one embodiment, the user does not know how many technological areas are in the input data, thus using an unsupervised classification algorithm Latent Dirichlet Allocation (LDA).

LDA requires the number of classes being set as a parameter and to estimate this and final classifier performance, the system calculates the Kullback-Leibler (KL) divergence value for different number of topics. The user can use the KL divergence values to estimate the optimal number of classes. The user can select to use KL divergence values to automatically set the number or topics or suggest different number of classes to the user. In this embodiment, ex-post classification the user is provided by wordclouds based on word to topic probabilities in which the user can evaluate topic content and cohesion.

In a technology scanning application, user assessment is required to create strategic and operational understanding from the results. This requires a convenient method of producing the results to the user. The results of the classification can be represented as a computer user interface at least one of the following: tabulated data and visual network representing the results. In one embodiment, results can be given as a table where columns represent different meta data fields and the classification of the item and rows represent individual items. This approach is particularly relevant to hard classification. In one embodiment, results can be given as a npartite network where nodes are defined by different types; items, classes and meta data fields. Edges between nodes are defined by a link between nodes created through the classification or existing meta data. The npartite network can be visualized as a graphical network.

By combining original meta data from the database to the classification results, user can evaluate the classification results. Further, a user can evaluate the relevance of items in the result and select items for further analysis. This is done either by selecting data from the tabular representation, and/or selecting areas or nodes from the network. Per user action, the selected data is reclassified and represented to the user creating a iterative refinement process. The user can iterate through multiple rounds of classifying and selecting relevant data points to be reclassified until the number of item equals one.

In one embodiment, the user is given a representation of the whole global patent data or other data. The user can select via a tabular interface or a visual representation patents the user is interested into and filter out patents that are irrelevant to the user. After selection, the user can iterate the model creation to create a more refined model. The user can then re-evaluate the result, select relevant and omit irrelevant. The user can select to iterate until there is only 1 patent document or other document in the dataset.

The user can complement data anytime by inputting any similar type of item to the model Similar type of item is defined based on the type of documents used to create the model. If the model is based on processing of text documents then similar type of document is also a text document. The user can create a similar document via human process using expert opinion or using a semi-automated approach where text is generated automatically based on a seed input.

In one embodiment, a user can create a document resembling a patent document. This can be a company internal invention disclosure document or an unsubmitted patent application document. An automated process can be used to create text from user key terms. Creating automated text can be achieved by, but not limited to, machine based summary of documents relevant to the key terms inputted by the user or, using Generative Adversarial Networks that create synthetic text from the input created by the user. In one embodiment, documents selected relevant by the user are used to train a Recurrent Neural Network model. For example, the user has filtered the Latent Dirichlet Allocation (LDA) through several iterations to only include 5 000 patents deemed relevant to the technology scan on e.g. elevators. These are used to create a model using the Recurrent Neural Network. The created model is then seeded with user selected key terms., e.g. the user can use a describing sentence or a list of key words to create a synthetic patent document. This synthetic document can be edited by the user and then fed into the the next iteration of the LDA model.

The inputted item is preprocessed and tokenized with the similar schema than the original item. The new items are thereafter included to the model and all subsequent tabular and visual representations of it. In one embodiment, the user can include non-disclosed patent documents to any iteration of the model. These inputs are preprocessed and visualized as a part of the model in the tabular and visual representation of the output. The user can define any and all meta data relevant to the input. The user inputted content is specific to a unique user identification code and not visible to any other user. In one embodiment, the user can define key phrases describing the idea. In addition to the user, the system administrator can anytime introduce new and similar type data to the data storage. Similar type refers to if the model is text document. Then the complement should be also text documents. In one embodiment, the patent administration publishes new patents which have not been included to the database. The new documents are sourced from the patent administration and included to the database as new and similar documents. The new patent documents are preprocessed and tokenized with the similar schema than the original the new items are thereafter included to the model and all subsequent tabular and visual representations of it. In one embodiment, the administrator adds new patents that have become public. These patents are introduced to all models created by user and the user is notified of new patents meeting the filtering and iteration requirements set by the user. The user can select relevant patents to be included and omit irrelevant patents.

The network visualization of the classifier is based on a graph representing the links between items and classes that can be visualized using multiple tools including but not limited to D3.js, Sigma,js, Gephi, NetworkX or SNAP.A link between nodes represent a relationship created by the classifier. The network is a bipartite or npartite graph, where links are either binary or weighted based on the type of classifier selected by the user. In one embodiment the network visualization is based on a soft classification created from Latent Dirichlet Allocation. The nodes represent documents (patents or user derived similar documents) and topics (classes) created by the algorithm In this embodiment, the documents are linked to topics based on the probabilities created by Latent Dirichlet Allocation. This embodiment is a bipartite network where links exist between documents and topics.

In one embodiment, the user can enrich the network to a npartite network by adding meta data driven links, such as edges between patents from the same inventor or applicant. The position of the nodes represents the strength of the relationship and the position of the node determines the structure and shape of the graph. The user can interact with the graph by for example zooming and/or select areas or individual nodes. In some embodiments, the nodes can have varying size based on network metrice, such as but not limited to out-degree or in-degree or its relevance score drawn from the classifier.

In some embodiments the bipartite of npartite graph can be transformed to one-mode. The user can select if the one-mode contains relationships between item or classes. In some embodiments the visualization can also be clustered using for example but not limiting to a modularity algorithm.

### WORKING EXAMPLE #1

A user wants to create a technology and patent map of graphene technology in general, and in particular of the use of graphene in transistor CMOs (Complementary metal-oxide-semiconductor). The user also wants to create a technology and patent map to set-up continuous scanning of graphene technology in general, as well as in particular scan the developments with transistor CMOs.

The working example can be implemented through a computer device that contains all necessary data, software and other elements locally, or be connected to the Internet and other computers, servers, and computer networks. The working example can include the user working through a graphical interface, row-command, or other means. The user needs to have access to a knowledge base of documents stored in a database or data warehouse 120, modelling (i.e. classification) engine 150, and means of accessing results of modelling and visualization.

The first step for the user is to identify and select all patent records from desired document collections where the term “graphene” is present. The term must be present in at least one of the following: description, title, claims, and abstract, but other records fields can be used as well.

This text mining is enabled by indexing a database or data warehouse containing global patent data with Apache Lucene indexing solution or Elastic Search. The index can include all data and fields present in the data base or data. By executing text mining commands via a computer terminal with row-commands or through GUI, the user selects all records that are captured by the index.

This step is implemented by enabling the user to access to the knowledge database 120 of documents through a GUI or terminal access. The knowledge base can be located at a local computer or server, or be located at a cloud-based server or other remote server to which the user has access.

This text mining produces a selection of documents, which the user sends to modelling 122 that with the use of classification engine 150, such as LDA, generates soft and hard partitioning. The number of topics to be created, in the case of LDA, can be determined by the user by tools available at the GUI, or by providing commands at a terminal interface.

In this example, the user decides to create 10 topics in the modelling, as this is a intuitive reasonable number of patents for a body of records less than 10 000.

The number of topics can also be recommended by using a computer generated estimation of best number of topics for the given body of documents and corpus using for example the Kullbeck-Leibler (KL) divergence. The KL divergence values can be used by fully automatically setting the number of topics. For advanced users the KL divergence is given as a graphical plot showing KL divergence for a range of topics letting the user select the optimal number of topics from the plot. Thus the number of topics generated during the modelling can be set by automated, semi-automated, or manual methods.

Data created by the modelling is integrated to the knowledge database 120 via a unique identified, and thereby all data and information created by the modelling can be connected to bibliographic information of each patent record, research publication, or other document. The knowledge base can also contain the original document files, such as PDF files of original patent records or research publications, image files, full text description and claims, and so on. The knowledge base can also link the modelling created data and information to enriched data or to third party databases, such as company financial information or inventors' social media accounts, curriculum vitae information, and other data and information sources.

The modelling creates also machine readable data and information that are used to create visualizations, landscapes, and maps of the document collection, as well as support a wide range of statistical analysis possibilities. The modelling outputs and stores such data and information by at least one of the following methods: automatically semi-automatically or by user prompt directly to a database, visualization engine or other archive.

The second step concerns the evaluation of the quality of created model. One method to evaluate the quality of the model is human evaluation and is carried by the user by reviewing statistical, visual and other evidence of the generated model.

The user gains an understanding of what the machine learning generated topics are by accessing visualizations of each topics. The visualizations are created by generating a word cloud from the full-text description of patents assigned to a given topic, or from other elements in the patent document such as technology classifications, titles, abstracts, applicants, assignees and so forth.

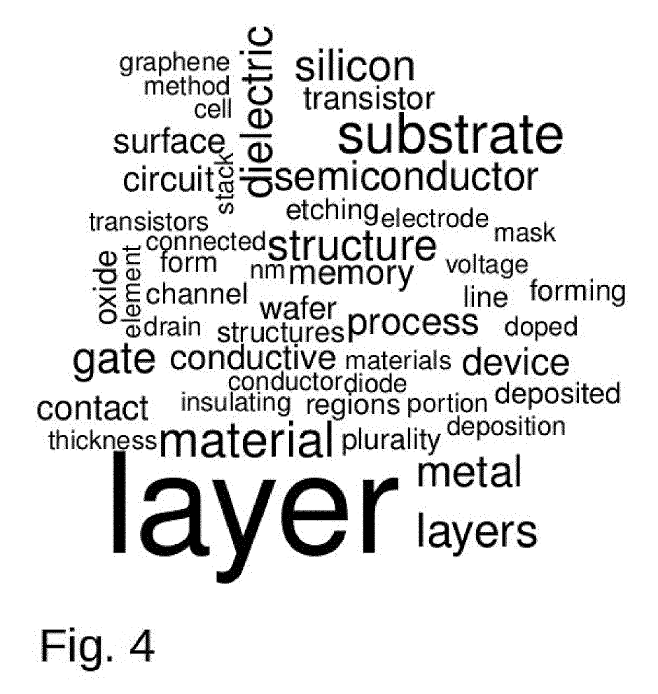

FIG. 4 presents an example of topic visualization with word cloud drawn from the description of all patents hard partitioned to topic 3.

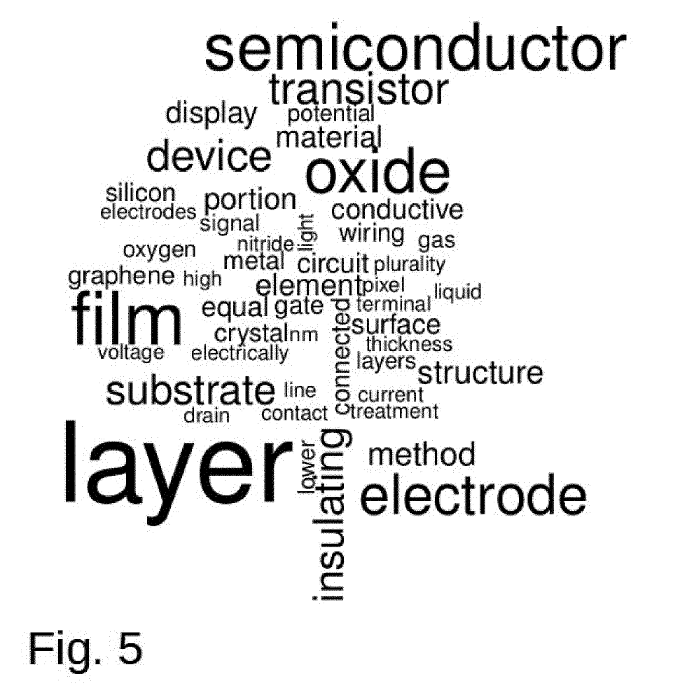

FIG. 5 presents an example of topic visualization with word cloud drawn from the description of all patents hard partitioned to topic 6.

Based on FIGS. 4 and 5, the user can make a reasonable conclusion or assumption that topics 3 and 6 are closely related, given that the terms that appear in the wordclouds are to some degree overlapping. However, the user must also conclude or assume that there are some important differences between the topics 3 and 6, of which some can be deduced from the wordclouds and some would require the user to use other means to have concrete evidence.

By visually inspecting the topic visualizations, the user will gain basic understanding of what type of technology and business areas each topic represents, and how they correspond to user's needs. The topics can be visualized also through other means.

The use can also evaluate the quality of a topic through statistical data. For example, the user can maintain that a patent, for example the patent record US2016104778 (A1), Graphene base transistor and method for making the same, embodies or describes his or her knowledge interest. By investigating how this patent is classified in the model, the user gains an understanding of the machine generated classifications which in this user case are topics.

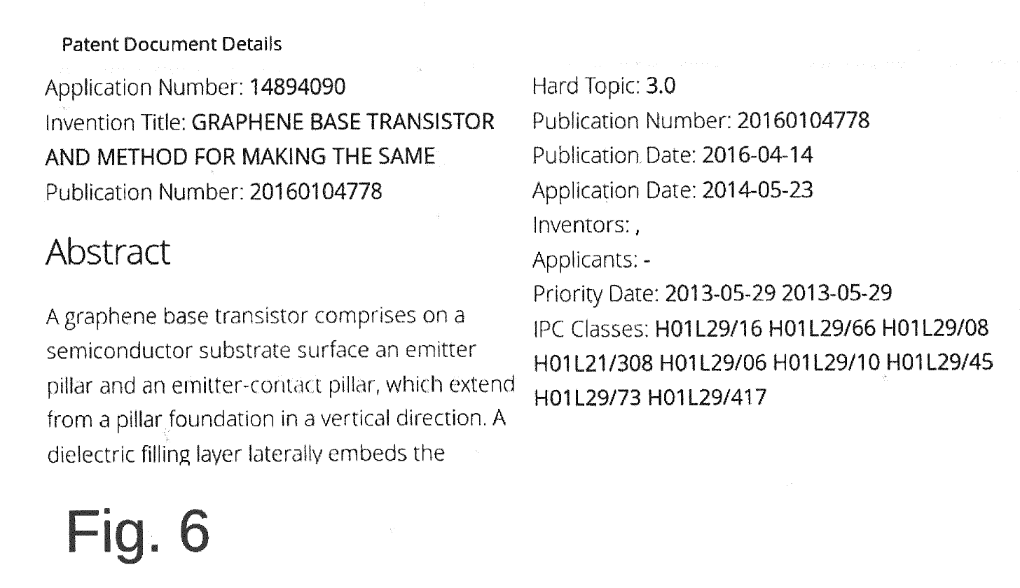

FIG. 6 presents in topic relevance evaluation how the user can open at the GUI a record level view of the high-interest record for closer evaluation. The record level information depicts also the hard classification topic.

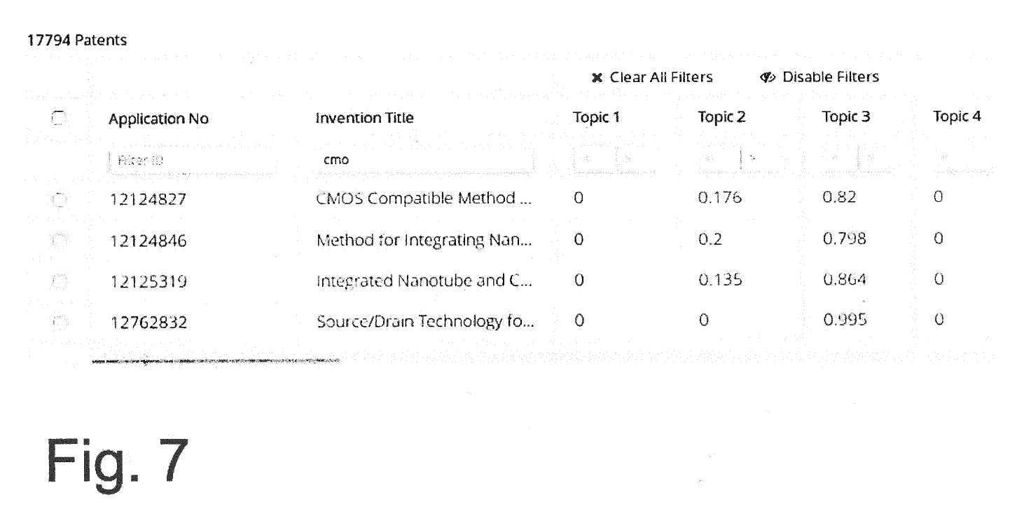

In FIG. 7 evaluation of topics through statistical profile of records describes how the GUI enables the user to access the soft partitioning results of the modelled documents. The GUI provides the statistical profile of each record as created in the modelling. The GUI allows the user also to filter or browse the records to locate of records of high interest, and thereby also to see the statistical profile of these records.

In FIG. 7 the user has chosen to see the statistical profile of the patent application US2016104778 (A1), graphene base transistor and method for making the same. This can be done by patent number search or title filtering, or other means. In this example, the user has filtered from all the records all patents with the terms “graphene base transistor” in the patent title field, resulting in 5 records.

The records have very similar titles, indicating that they are technologically highly related. The overview display confirms also that all the records have received highest relevance scores in Topic 3, and overall their Topic relevance scores show similarities. Thus the user can infer that by identifying patents that receive relevance score above certain threshold to Topic 3 are potentially important to him or her.

In the GUI, the user can filter all records by statistical threshold value (lower, higher, or equal to) in one or more topics, and thereby isolate collections of documents for closer examination or processing. The same operation can also be implemented by any other computer interface by command lines or other execution methods.

A visual map or landscape can also be created from the data created by the modelling. There are several methods to implement this and that are realized by the user by using the GUI.

The user can also create the map by special purpose software, such as Gephi (https://gephi.org/). The modelling exports automatically nodes and edges data compatible with the visualization and network analysis software. The edges and nodes data is loaded to Gephi or equal software programme or package automatically or by the user. The system automatically calculates basic network descriptives for the user, such as the number of nodes and edges, and find clusters/communities in the data. The position of nodes in the visualization is based on a default or user selected algorithm, such as OpenOrd layout. This is followed by visualizing the attributes of the resulting network, for example by assigning color to different modularities.

The user accesses the network visualization or landscape via the GUI. The user can further evaluate the quality of modelling created topics by exploring how network analysis and visualization places them. Topics that appear similar or related to the user based on the above described wordcloud visualizations of topics should also be placed close to each other in the Gephi created network analysis. Similarly, the user can conclude or assume that topics that receive similar relevance scores for records that include similar information, such as technologically closely related patents, should show strong network ties in network analysis or visualizations that employ network data. In this example, the user has identified a number of similar patents that use graphene in transistors, and all they have received high relevance scores in topic 3 and 6.

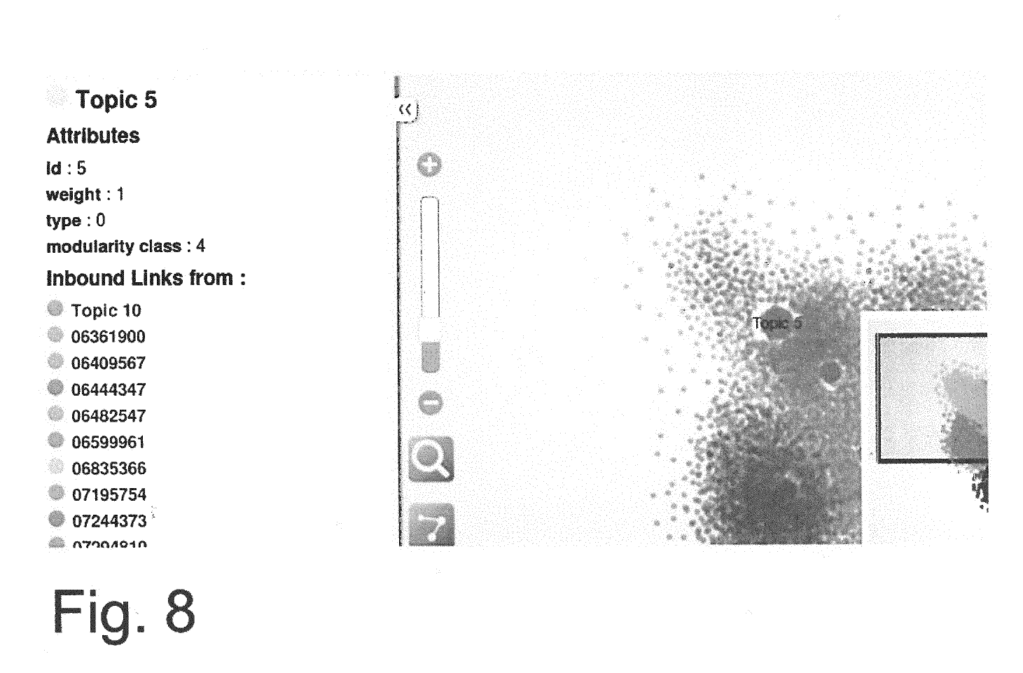

FIG. 8 presents how a user can evaluate modelling created topics or how they are related to each through a network visualization that in this case is created with the above described process and Gephi software.

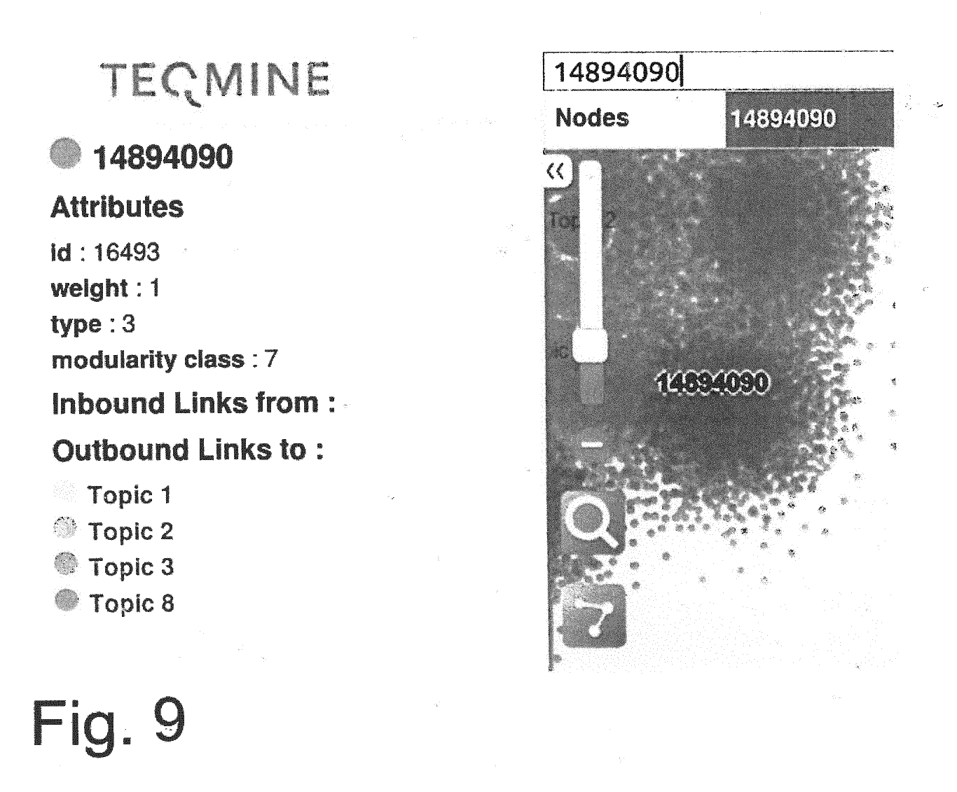

FIG. 9 presents how by clicking at the GUI for the patent landscape of the record US2016022819 (A1), Medical Implant, the user is able to retrieve information about the patent, including modelling or network analysis generated information, or information stored at the knowledge base. The user is also able to explore other records in the GUI.

Through the GUI the user can access the network visualization or other landscape visualization, and explore how different topics are related. Furthermore, the user can explore the document collection in the landscape as it includes representations of the modelling created data and information, as well as on each collection document included in the model.

The visualization or landscape represented in the GUI is linked to the knowledge base 120 and all bibliographic, images, original patent or research publication pdfs, full-text descriptions and claims, links to third party sources, enriched data, as well as other data, analysis and information related to a collection document can be accessed through the GUI.

The user can access record level data through interactive means, e.g. by moving the computer screen pointer over a collection document and double-clicking with a mouse, which prompts the GUI to display information on the said collection document. The user can save selected records to a specific MyList or MyCollection through landscape.

The third step in the patent map or landscape creation is to isolate high relevance patents, that is transistor CMO related patents, within the broader graphen patent map. Whereas the user has recognized that such patents have high probability to have received high relevance scores in topic 3 and 6, he or she still faces the dilemma that these topics also include a lot of non-relevant patents.

Therefore the meta-data of the documents selected to the map and included in the GUI is indexed with traditional indexing methods, such as Lucene or Elastic Search. Through the GUI, the user can run specific searches to identify records that have high relevance terms or technology classification, and archive such records to dedicated MyList or MyCollection that is an electronic archive. The creation of such curated collection of documents allows the user to create and maintain a collection of highly specialized documents.

Through the GUI, the user enters a Boolean search for the following terms in the patent description field: “transistor CMO*” OR “complementary metal-oxide-semiconductor” OR “complementary metal oxide semiconductor”. The results of this query are saved to a curated MyList, which can be named e.g. “transistor CMOs”. The user can save the query so that it is run automatically always when the model is updated or model data is updated with new documents, enabling the user automated scanning of well-defined high-relevance technology area.

Upon defining a high-interest technology area through modelling generated topic area, by using modelling generated classification data, or human curation, the user creates curated collections of data that can be called MyLists or MyCollections.

The user can access the such curated collections through the GUI and view individual documents. The user can invite other people to examine the curated collections, and the users can curate collections collectively.

The GUI supports automated analysis, visualization and reporting for further exploration, analysis and other work. The GUI includes sections with analysis templates, such as as tables calculating the number of records per topic year, or number of patents per inventor per year, etc. The user can also create custom made information tables or queries. An example of such query would be to compare the patent portfolio of different companies in the broad graphene patent landscape, or within the narrower transistor CMO landscape.

All model data, curated collections, or user made queries and filtered results can also be visualized in a number of ways with a chart engine within the GUI. Examples of such chart engines are High Charts (www.highcharts.com), Tableu, (www.tableu.com) or Vaadin (www.vaadin.com).

### WORKING EXAMPLE #2

In some cases, the user wants to create a high precision map of very detailed technology area. It can be the case that the collection of documents selected for modelling as exemplified in the working example #1 is so large that continues to include a large number of low relevance documents, or “noise”.

In such a case, the user can select a sub-group of documents from the first collection, and create another round of modelling. In this working example, the user wants to focus exclusively on the transistor CMO related patents within the broader graphene space, as discussed above.

The user creates a model as described in Working Example #1, and then by using a patent that embodies his or her knowledge interests, selects a sub-group of documents for another round of modelling.

In this case, the user considers that the US2016104778 (A1), Graphene base transistor and method for making the same, embodies or describes his or her knowledge interest. The user analyzes the soft partitioning results of the first modelling in the GUI or another computer terminal, and selects records that have received similar relevance scores. In this case, the user could select all patents that have a relevance score 0.10 or higher in topic 3 for another round of modelling.

Doing the selection in this manner, the user trusts that the classification, or topic relevance scores, created by the classification engine is able to capture relevant patents. Each patent that has some similar text or features than the patent US2016104778 will also receive some similar relevance scores. Thus, if the similarities occur within features described by topic 3, the user can be able to identify records that have relevant similarities with his or her interest only through statistical means.

The selection method of relevant documents for another round of modelling can also be automated. As the user starts the first round of modelling, he or she can identify a high relevance document (knowledge objective document, hereafter KOD) or insert such a document into document collection to be modelled. After the modelling the system automatically analysis the statistical profile of the KOD, and chooses all records with similar statistical profile or all records with a relevance score in topics where the KOD has received high relevance scores. The user can define the threshold relevance score for selection, or it can be implemented automatically via a number of statistical methods.

With this selection method, the user can implement at least 2 modelling rounds. Each modelling round allows the user to refine the technology and patent landscape and increase its accuracy and relevance.

Each modelling round creates also log information for each document that has been modelled, as well as log information about the model. The log information is stored at a database, and can be used for automating the modelling rounds for subsequent data that is received as updates to the collection. The log file information is used to control and manage the subsequent automated modelling rounds. The system according to the invention can comprise a log for documenting the parameters and possible other features of each round of modelling and for performing the automated execution of identical modelling rounds in the case of for example new data coming available.

### WORKING EXAMPLE #3

The user wants to implement at least the Working Example #1, but can also want to implement other working examples described so that he or she is able to integrate into the modelling data a private collection of data not available in the knowledge database 120. The user may have one or more unpublished invention disclosures describing future patent applications, and the user wants to create a technology or patent map specific for this document or collection of documents.

The GUI or other terminal interface includes a possibility for the user to upload such a private document or collection of documents and to be included into the modelling. The document or collection of documents can include meta-data, such as date, author, inventor, owner, etc.

The document or collection of documents is uploaded by using API or APIs that stores the user specific document or collection of documents in his or her private collection within the knowledge base, and it is not accessible to other users unless the user or user organization permit access or sharing.

The purpose of integrating private documents or collection of documents is to allow the user to map, landscape, visualize and analyze seamlessly private collections, and whose analysis otherwise would require significant work effort.

### WORKING EXAMPLE #4

The user may not have a specific point of departure for the patent mapping or landscape exercise. The user may not have KOD or other document as readily available.

The user may, however, have an idea what type of technology or patent information he or she is interested to explore.

To this end, the system includes a complete map model of the global patent data, implemented for example with the LDA. This model is created by modelling with LDA the full-text descriptions of the complete repository of USPTO patent data from 1978 onwards, and the model may also include the the English language full-text descriptions of the EPO and PCT patent publications since 1978, as well as the full-text descriptions of patents submitted in other languages but translated into English. The model may also include further document collections, such as other patent authorities, research publications, research databases, software, product descriptions, white papers, thesis, and so forth.

The user may explore the readily available model through the GUI or other computer terminal in ways described in Working Examples described above. The user may select a sub-group of data for another round of modelling in ways described above.

The readily available model may be based on model trained with historical data, or it can be based on model that is trained anew every time new data is added to the collection.

The user may find the readily available model, or map or landscape of global patent data sufficient for the discovery needs at hand, and no further modelling is carried out.

However, by enabling the user the possibility to choose a sub-group of documents for analysis, the user can carry out one or more rounds of further modelling as described in working examples above.

In this working example, the user accesses via the GUI or other computer terminal the data and information created by modelling the complete USPTO full-text patents and applications since 1978. The model also includes all EPO and PCT English language full-text descriptions, totaling together more than 14 million publications.

The user considers the US2016104778 (A1), Graphene base transistor and method for making the same, to embody or describe his or her knowledge interest. The user analyzes the soft partitioning results of the readily available modelling in the GUI or another computer terminal, and trigger further rounds of modelling and more precise technology and patent maps as described above.

The user may also insert his or her KOD, or other private document, or a collection of documents, into the readily available map. This would serve the purpose of enabling the user easily to identify a document or groups of documents that are relevant to user's knowledge interests.

The user can also identify sub-groups of relevant patents through other means as described above.

### WORKING EXAMPLE #5

The user needs to scan, or monitor, a specific technology or patent area indefinitely. Having created a special purpose technology or patent map or landscape as described above, the user may set the system to perform the previous steps automatically as new documents are added to the knowledge database 120.

The system includes a log file, which can be a file, database or other computer stored file, which includes instructions to reproduce exactly the steps by which the user has created a specific model. The log file includes information on at least one of the following steps: user's document selection criteria for the first round of modelling, user's document selection criteria for other rounds of modelling, modelling parameters, filtering and search criteria for curated collections, relevance profile of KOD or KODs and associated selection criteria, user's selection of supervised, semi-supervised or supervised selection criteria for modelling after the first modelling, and other user specific parameters.

The log file can be handled through an API, but it can be realized also through other means in the system. In the GUI or other computer terminal, the user may configure the system to perform. Setting-up a technology scanning. The user can save the query so that it is run automatically always when the model is updated or model data is updated with new documents.

### WORKING EXAMPLE #6

The user is interested in a specific area, such as graphene, but does not have access to specific internal document to be used in modelling. The user has narrowed down a specific area by working example #4 and then uses the machine to automatically create a synthetic patent document that the user can use as a KOD or for any internal purposes, such as writing an patent application.

Selecting the documents of interest in a specific field of technology, the user prompts the text generation modelling. This process takes all of the user defined documents and creates a model, based for example on Recurrent Neural Network. This model can thereafter be used to automatically create synthetic text.

After the model has been successfully created the user is promoted to give seed terms to be used as a starting point for the synthetic patent document. The user selects interesting seed terms that are important to the application are of the user. Giving the machine the seed values the machine automatically generates a synthetic text.

After text generation the user can select to give a new seed value and produce a new synthetic text document, download the created document, edit the created document in a text editor, save the document in the archiving system and/or include the document in to any models created during the process.

The user can also use the document to run similarity queries as per described in patent application U.S. Ser. No. 15/212,103.

The presented means 100(a, b), 102, 104, 106, 108, 110, 112, 114, 116, 118, 150, etc., for performing different kind of tasks according to the present invention can be carried out programmatically by utilizing e.g. algorithm techniques and/or programs by means of data processor techniques and data processors such as e.g. computers.

Thus, while there have been shown and described and pointed out fundamental novel features of the invention as applied to a preferred embodiment thereof, it will be understood that various omissions and substitutions and changes in the form and details of the invention may be made by those skilled in the art without departing from the spirit of the invention. For example, it is expressly intended that all combinations of those elements which perform substantially the same results are within the scope of the invention. Substitutions of the elements from one described embodiment to another are also fully intended and contemplated. It is also to be understood that the drawings are not necessarily drawn to scale but they are merely conceptual in nature. It is the intention, therefore, to be limited only as indicated by the scope of the claims appended hereto.

1. An automated analysis system for analyzing at least one of scientific, technological and business information, characterized in that, the automated analysis system comprises means for processing a data amount to accomplish a collection data form, means for structuring the collection data form describing the content of a source document, means for automatically identifying input documents in data warehouses comprising similar structured data forms as said structured collection data form, means for preprocessing and tokenizing said input documents, and the automated analysis system comprises a classification engine using the tokenized and preprocessed documents as input classifying each item of the input documents, and said means for processing, means for structuring, means for automatically identifying, means for preprocessing and tokenizing and said classification engine being configured to perform their tasks in one or more modelling round(s).

2. An automated analysis system according to claim 1, characterized, in that the system comprises a log for documenting the parameters and possible other features of each round of modelling and for performing the automated execution of identical modelling rounds.

3. An automated analysis system according to claim 1, characterized, in that the classification engine is configured to enable the user to filter the input documents, change the classifier, and change the representation of classifier parameters or results based on demand.

4. An automated analysis system according to claim 1, characterized, in that the system is configured to enable the user to complement data by inputting any type of document to the model.

5. An automated analysis system according to claim 1, characterized, in that the analysis system comprises means for representing results of the classification as a computer user interface as at least one of tabulated data and visual network representing the results.

6. An automated analysis system according to claim 1, characterized, in that in the system collection of data is sourced from publicly available data in at least one of structured format, web harvested and proprietary format.

7. An automated analysis system according to claim 1, characterized, in that the analysis system comprises means for structuring collection of data to at least one of meta information and semantic text, figures, tables, video and audio describing content of the document.

8. An artificial intelligence system for creating a synthetic document, wherein the system is configured to model text generation on basis of selected documents of interest in a specific field to form a model to which seed terms are given to be used as a starting point for the synthetic document, and the system is configured to automatically generate synthetic text on basis of the formed model and given seed terms to create the synthetic document.

9. An automated analysis method of analyzing at least one of scientific, technological and business information, characterized in that, in the automated analysis method is processed a data amount to accomplish a collection data form, is structured the collection data form describing the content of a source document, is automatically identified input documents in data warehouses comprising similar structured data forms as said structured collection data form, is preprocessed and tokenized said input documents, and is classified using the tokenized and preprocessed documents as input documents classifying each item of the input documents, and said processing, structuring, identifying, preprocessing, tokenizing and said classification being configured to perform their tasks in one or more modelling round(s).

10. An automated analysis method according to claim 9, characterized, in that in the method is documented parameters and possible other features of each round of modelling and for performing the automated execution of identical modelling rounds in the case of for example new data coming available.

11. An automated analysis method according to claim 9, characterized, in that in the method is configured a system to enable the user to filter the input documents, change the classifier, and change the representation of at least one of classifier parameters and results based on demand.

12. An automated analysis method according to claim 9, characterized, in that in the method is configured a system to enable the user to complement data by inputting any type of document to the model.

13. An automated analysis method according to claim 9, characterized, in that the results of the classification are represented in a computer user interface as at least one of tabulated data and visual network representing the results.

14. An automated analysis method according to claim 9, characterized, in that in the method is sourced a collection of data from publicly available data in at least one of structured format, web harvested and proprietary format.

15. An automated analysis method according to claim 9, characterized, in that the analysis method is structured collection of data to at least one of meta information and semantic text, figures, tables, video and audio describing content of the document.

16. An artificial intelligence method for creating a synthetic document, wherein is modelled text generation on basis of selected documents of interest in a specific field to form a model to which seed terms are given to be used as a starting point for the synthetic document, and is automatically generated synthetic text on basis of the formed model and given seed terms to create the synthetic document.
